(19) United States
(12) Patent Application Publication
(10) Pub. No.: US 2025/0392141 A1
(43) Pub. Date: Dec. 25, 2025

(54) POWER SUPPLY SYSTEM

(71) Applicant: YAZAKI CORPORATION, Tokyo (JP)

(72) Inventor: Masato Sasahara, Susono-shi (JP)

(21) Appl. No.: 19/216,606

(22) Filed: May 22, 2025

(30) Foreign Application Priority Data
Jun. 21, 2024 (JP) 2024-100150

(51) Int. Cl. H02J 7/00; H02J 7/34

(52) U.S. Cl. CPC H02J 7/00304; H02J 7/0063; H02J 7/34; H02J 2310/40

(57) ABSTRACT

A power supply system includes a power supply supplying power to a load via a first wiring, a storage battery storing power supplied from the power supply via a second wiring connected to the first wiring and supplying power to the load when the power supply fails to supply power to the load, a first switch provided on the first wiring between a connection portion with the second wiring and the power supply, a voltage conversion unit connecting the second wiring and the storage battery and stepping up and down a voltage of power supplied from the power supply, a second switch connected in parallel with the second wiring and the voltage conversion unit, a first fuse provided at an output unit of the voltage conversion unit and cutting off a current by being blown when a ground fault current flows thereinto.

### CROSS-REFERENCE TO RELATED APPLICATIONS

This application is based on and claims priority under 35 USC 119 from Japanese Patent Application No. 2024-100150 filed on Jun. 21, 2024, the contents of which are incorporated herein by reference.

### TECHNICAL FIELD

The present disclosure relates to a power supply system.

### BACKGROUND ART

There is known a power supply system in which, when power is supplied from a power supply to a load, a standby power supply such as a storage battery is also supplied with power and charged, and power is supplied from the standby power supply to the load when power cannot be supplied from the power supply to the load. In this power supply system, power supplied from the power supply may be boosted by a voltage conversion unit such as a DC/DC converter and supplied to the standby power supply to increase a voltage of the standby power supply (for example, Patent Literature 1).

### CITATION LIST

### Patent Literature

Patent Literature 1: JP2023-7922A

SUMMARY OF INVENTION

In a power supply system described in Patent Literature 1, however, an input and output unit of a voltage conversion unit is provided with a switch that cuts off a current to protect the voltage conversion unit from a ground fault current when the input and output unit has a ground fault. For this reason, a circuit for controlling the switch is necessary, resulting in a complicated configuration and increased cost for the switch itself.

The present disclosure is made to solve such a problem, and an object of the present disclosure is to provide a power supply system that, even when the power supply system includes a voltage conversion unit that steps up and down a voltage of power supplied to a standby power supply, can protect the voltage conversion unit from a ground fault current with an inexpensive and simple configuration.

A power supply system of the present disclosure includes a power supply that supplies power to a load via a first wiring; a storage battery that stores power supplied from the power supply via a second wiring connected to the first wiring and that supplies power to the load when the power supply fails to supply power to the load; a first switch that is provided on the first wiring between a connection portion with the second wiring and the power supply and is conducted when the power supply supplies power to the load; a voltage conversion unit that connects the second wiring and the storage battery and that steps up and down a voltage of power supplied from the power supply; a second switch that is connected in parallel with the second wiring and the voltage conversion unit and that is conducted when the storage battery supplies power to the load; a first cutoff unit that is provided at an output unit of the voltage conversion unit and that cut off a current when a ground fault current flows in; and a second cutoff unit that is provided at an input unit of the voltage conversion unit and that cut off a current when a ground fault current flows in. The first cutoff unit is a first fuse that cuts off a current by being blown when a ground fault current flows thereinto.

According to the present disclosure, it is possible to provide a power supply system that, even when the power supply system includes a voltage conversion unit that steps up and down a voltage of power supplied to a standby power supply, can protect the voltage conversion unit from a ground fault current with an inexpensive and simple configuration.

### BRIEF DESCRIPTION OF DRAWINGS

FIG. 1 is a configuration diagram showing a power supply system according to a first embodiment;

FIG. 2 is a flowchart showing operation of the power supply system;

FIG. 3 shows operation of the power supply system during normal traveling;

FIG. 4 shows operation of the power supply system during evacuation traveling;

FIG. 5 shows a case where an input unit and an output unit of a voltage conversion unit have a ground fault; and

FIG. 6 is a configuration diagram showing a power supply system according to a second embodiment.

### DESCRIPTION OF EMBODIMENTS

Hereinafter, the present disclosure will be described with reference to preferred embodiments. The present disclosure is not limited to the embodiments to be described below, and the embodiments can be appropriately changed without departing from the gist of the present disclosure. In the embodiments to be described below, there may be parts in which illustration and description of a part of a configuration are omitted, and it is needless to say that a public or well-known technique is appropriately applied to details of an omitted technique within a range in which no contradiction with contents to be described below would occur.

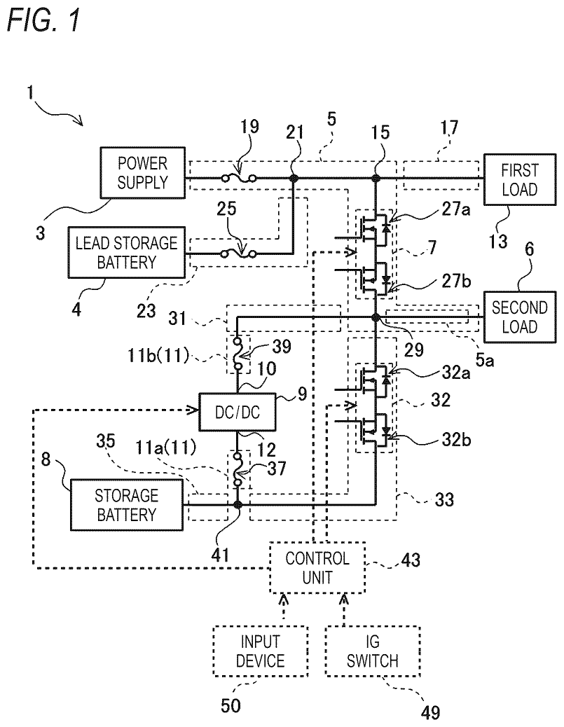

First, a configuration of a power supply system according to a first embodiment will be described with reference to FIG. 1. FIG. 1 is a configuration diagram showing the power supply system according to the first embodiment. Here, a system that is mounted on a vehicle having an autonomous driving function and supplies power to a load of the vehicle is described as an example of a power supply system 1. As illustrated in FIG. 1, the power supply system 1 includes a power supply 3, a lead storage battery 4, a storage battery 8, a first switch 7, a voltage conversion unit 9, a second switch 32, and a cutoff unit 11. The power supply system 1 further includes a control unit 43.

The power supply 3 is a device that supplies power to a load of the vehicle, and more specifically, is a battery such as a lithium-ion storage battery that supplies power to a first load 13 and a second load 6 (load). The first load 13 is, for example, a device and an on-board device that consumes power in the vehicle, and includes a necessary load and a general load. The necessary load is a load necessary for traveling of the vehicle, such as a steering device, a brake device, and a sensor. The general load is a load such as an on-board device including an air conditioner and an audio that is, although not necessary for traveling of the vehicle, provided for an occupant of the vehicle to comfortably stay in a vehicle cabin. The power supply 3 is connected to the first load 13 via a first wiring 5 and a first branch wiring 17. The first wiring 5 transmits power supplied from the power supply 3, and has one end connected to the power supply 3. A fuse 19 is provided at a connection portion with the power supply 3 on the first wiring 5. The first branch wiring 17 connects the first wiring 5 and the first load 13, and has one end connected to a contact 15 in the middle of the first wiring 5 and the other end connected to the first load 13. The second load 6 consumes power in the vehicle similarly to the first load 13, and includes a necessary load. The other end of the first wiring 5 is connected to the second load 6, and power is supplied from the power supply 3. A reason why the power supply system 1 supplies power by dividing the load of the vehicle into the first load 13 and the second load 6 is to provide redundancy in power supply, and specifically, to allow the vehicle to travel even when power is supplied only to, for example, the second load 6.

The lead storage battery 4 is a battery that supplies a dark current to the first load 13 and the second load 6, and is provided as necessary. The lead storage battery 4 is connected to the first wiring 5 via a second branch wiring 23. The second branch wiring 23 connects the lead storage battery 4 and the first wiring 5, and has one end connected to the lead storage battery 4 and the other end connected to a contact 21 that is closer to the power supply 3 than to the contact 15 on the first wiring 5. A fuse 25 is provided at a connection portion with the lead storage battery 4 on the second branch wiring 23.

The storage battery 8 is, for example, a lithium-ion storage battery that stores power supplied from the power supply 3 and supplies power to the second load 6 when the power supply 3 cannot supply power to the second load 6, and is supplied with power from the power supply 3 through the first wiring 5 and a second wiring 31. The second wiring 31 connects the power supply 3 and the storage battery 8, and has one end connected to a contact 29 (connection portion) that is closer to the second load 6 than to the contact 15 on the first wiring 5. A part of the first wiring 5 which connects the contact 29 and the second load 6 is also referred to as a connection wiring 5a. A case where the power supply 3 cannot supply power to the second load 6 means a case where an abnormality such as a ground fault, a power supply fault, an overvoltage, and a disconnection occurs in the power supply 3 and the first wiring 5, and necessary and sufficient power for driving the second load 6 is not transmitted from the power supply 3 to the second load 6. Whether an abnormality has occurred may be determined by a current flowing through the power supply 3 and the first wiring 5. Since the power supply 3 and the first wiring 5 are also used to supply power to the first load 13, the power supply 3 cannot normally supply power to the first load 13 when the power supply 3 cannot supply power to the second load 6.

The first switch 7 is conducted when the power supply 3 supplies power to the second load 6 and cuts off the conduction when the power supply 3 cannot supply power to the second load 6, and is provided between the power supply 3 and a connection portion (contact 29) with the second wiring 31 on the first wiring 5. In FIG. 1, the first switch 7 is provided between the contact 29 and the contact 15. As shown in FIG. 1, examples of the first switch 7 include N-channel metal-oxide-semiconductor field-effect transistors (MOSFETs) 27a and 27b. As shown in FIG. 1, when sources of the MOSFETs 27a and 27b are connected to each other, directions of rectification of parasitic diodes are opposite to each other, and conduction can be reliably cut off when the switch is turned off.

The voltage conversion unit 9 steps up and down a voltage of power supplied from the power supply 3, and connects the second wiring 31 and the storage battery 8. More specifically, the voltage conversion unit 9 includes an input unit 10 connected to the other end of the second wiring 31, and an output unit 12 connected to the storage battery 8 via a fourth wiring 35. The fourth wiring 35 connects the output unit 12 of the voltage conversion unit 9 and the storage battery 8. The voltage conversion unit 9 is, for example, a DC/DC converter and operates when the vehicle is started. Specifically, when the vehicle is started, the voltage conversion unit 9 steps up and down the voltage of the power supplied from the power supply 3 and supplies the power to the storage battery 8, and stops operation when the storage battery 8 is fully charged. A case where the storage battery 8 is fully charged is a case where a remaining battery level of the storage battery 8 is equal to or greater than a prescribed remaining level threshold. The remaining level threshold is, for example, a remaining level in a case of full charge.

The second switch 32 is conducted when the storage battery 8 supplies power to the second load 6 and cuts off the conduction when the power is not supplied, and is connected in parallel to the second wiring 31 and the voltage conversion unit 9. In FIG. 1, the second switch 32 is provided on the third wiring 33. The third wiring 33 connects the contact 29 and the fourth wiring 35, and has one end connected to the contact 29 and the other end connected to a contact 41 provided on the fourth wiring 35. The contact 41 is also a part where the voltage conversion unit 9 and the fourth wiring 35 are connected. Examples of the second switch 32 include N-channel MOSFETs 32a and 32b, which is similar to the first switch 7. As shown in FIG. 1, when sources of the MOSFETs 32a and 32b are connected to each other, directions of rectification of parasitic diodes are opposite to each other, and conduction can be reliably cut off when the switch is turned off.

The cutoff unit 11 cuts off a current when a ground fault current flows, and a pair of cutoff units are respectively provided at the input unit 10 and the output unit 12 of the voltage conversion unit 9. Here, in the pair of cutoff units 11, a first cutoff unit 11a (cutoff unit) provided at the output unit 12 is a first fuse 37 that cuts off the current by being blown when the ground fault current flows thereinto. The first fuse 37 can be a known fuse in which a cutoff current is equal to or less than the ground fault current and is larger than a current flowing through the output unit 12 when power is supplied to the storage battery 8. With this configuration, when the output unit 12 of the voltage conversion unit 9 has a ground fault, the ground fault current flows from the storage battery 8 toward the output unit 12 of the voltage conversion unit 9, and the voltage conversion unit 9 is protected since the first fuse 37 is blown by the ground fault current. A case where the output unit 12 of the voltage conversion unit 9 has a ground fault is a case where the output unit 12 is grounded due to a failure such as a short circuit of a field-effect transistor (FET), a capacitor, and the like in the voltage conversion unit 9. In this way, in the power supply system 1, when the output unit 12 of the voltage conversion unit 9 has a ground fault, the ground fault current is cut off by the first fuse 37 being blown, and thus it is not necessary to provide a switch for cutting off the ground fault current or a control circuit for controlling a switch in the output unit 12. The first fuse 37 may be a known fuse and no control circuit is necessary, and thus the first fuse 37 is less expensive than a switch. Further, the first fuse 37 has a simple structure as compared with a structure in which the ground fault current is cut off by a switch and a circuit that controls operation of a switch. For this reason, the power supply system 1 can protect the voltage conversion unit 9 from the ground fault current that flows thereinto from the output unit 12 with an inexpensive and simple configuration as compared with a configuration in the related art in which the ground fault current is cut off using a switch and a control circuit, and can prevent smoke generation or ignition of the voltage conversion unit 9 due to the ground fault current.

In the pair of cutoff units 11, a second cutoff unit 11b (cutoff unit) provided at the input unit 10 is a second fuse 39 that is blown when a ground fault current flows thereinto. The second fuse 39 can be a known fuse in which a cutoff current is equal to or less than the ground fault current and is larger than a current flowing through the input unit 10 when power is supplied to the storage battery 8. With this configuration, when the input unit 10 of the voltage conversion unit 9 has a ground fault, the ground fault current flows from the lead storage battery 4 toward the input unit 10 of the voltage conversion unit 9, and the voltage conversion unit 9 is protected since the second fuse 39 is blown by the ground fault current. A case where the input unit 10 has a ground fault is a case where the input unit 10 is grounded due to a failure such as a short circuit of a FET, a capacitor, and the like in the voltage conversion unit 9. In this way, in the power supply system 1, when the input unit 10 of the voltage conversion unit 9 has a ground fault, the ground fault current is cut off by the second fuse 39 being blown, and thus it is not necessary to provide a switch for cutting off the ground fault current or a control circuit for controlling a switch in the input unit 10. For this reason, the power supply system 1 can protect the voltage conversion unit 9 from the ground fault current that flows thereinto from not only the output unit 12 but also the input unit 10 with a less expensive and simpler configuration than that in the related art.

The control unit 43 controls connection and disconnection of the first switch 7 and the second switch 32, and connects and disconnects the first switch 7 and the second switch 32 by being connected to gates of the MOSFETs 27a and 27b and the MOSFETs 32a and 32b and controlling gate voltages. The control unit 43 also controls the operation of the voltage conversion unit 9. The control unit 43 is further connected to an ignition (IG) switch 49, which is a start switch of the vehicle, and receives either an ON signal indicating that the start switch is ON or an OFF signal indicating that the start switch is OFF. The control unit 43 is further connected to an input device 50. The input device 50 includes a switching device that transmits mode information indicating a driving mode of the vehicle to the control unit 43. Examples of the driving mode of the vehicle include an autonomous driving mode in which the vehicle is autonomously driven and a manual driving mode in which the vehicle is manually driven. The manual driving here means driving in which the control unit 43 controls traveling of the vehicle based on operation of a driver. The autonomous driving means driving in which the control unit 43 controls traveling of the vehicle without operation of the driver. The input device 50 further includes an acquisition device that acquires a remaining battery level of the storage battery 8 and transmits the remaining battery level to the control unit 43. The configuration of the power supply system 1 according to the first embodiment has been described above.

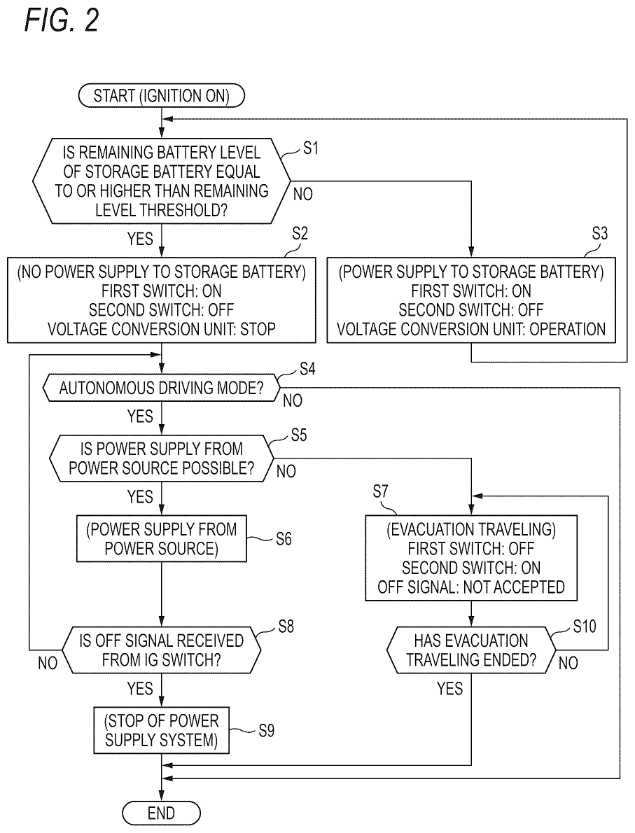

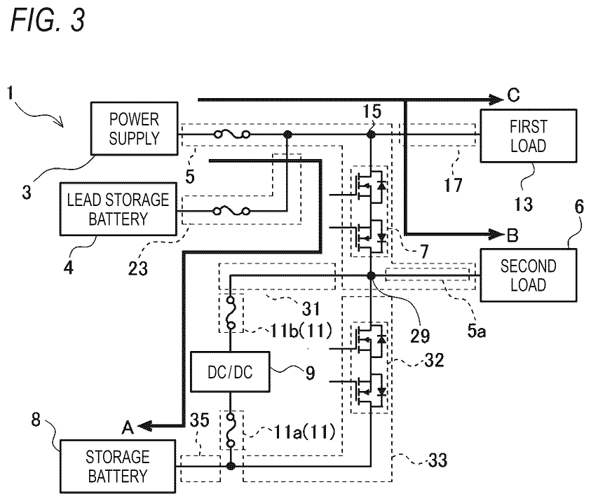

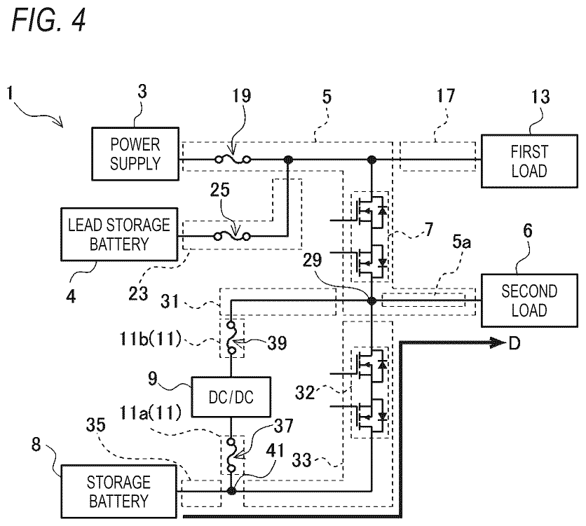

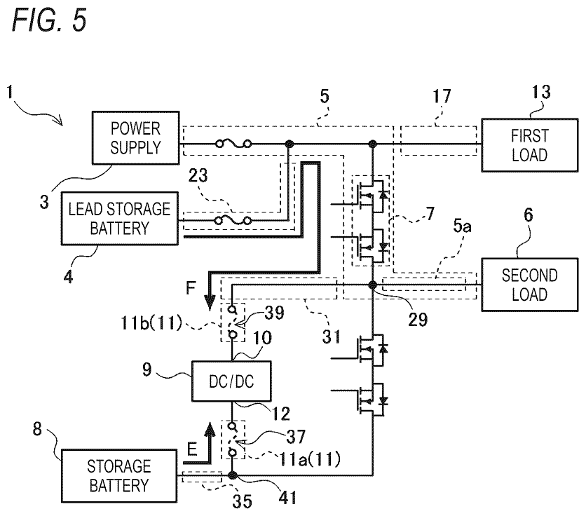

Next, operation of the power supply system 1 will be described with reference to FIGS. 2 to 5. FIG. 2 is a flowchart showing the operation of the power supply system 1. FIG. 3 shows operation of the power supply system 1 during normal traveling. FIG. 4 shows operation of the power supply system 1 during evacuation traveling. FIG. 5 shows a case where the input unit 10 and the output unit 12 of the voltage conversion unit 9 have a ground fault. Operation of the power supply system 1 described below is operation when the vehicle travels mainly by autonomous driving.

First, when receiving an ON signal from the IG switch 49, the control unit 43 refers to information indicating the remaining battery level of the storage battery 8 received from the input device 50 and determines whether the remaining battery level of the storage battery 8 is equal to or higher than a prescribed remaining level threshold. As a result, when it is determined that the remaining level is equal to or higher than the remaining level threshold, the process proceeds to S2, and when it is determined that the remaining level is not equal to or higher than the remaining level threshold, the process proceeds to S3 (S1 in FIG. 2).

When it is determined in S1 that the remaining battery level of the storage battery 8 is equal to or higher than the remaining level threshold, the control unit 43 does not supply power to the storage battery 8 to charge the storage battery 8 (S2 in FIG. 2). Specifically, the control unit 43 turns on and conducts the first switch 7 shown in FIG. 1, turns off the second switch 32 to cut off the conduction, stops the operation of the voltage conversion unit 9, and proceeds to S4. When it is determined in S1 that the remaining battery level of the storage battery 8 is not equal to or higher than the remaining level threshold, the control unit 43 supplies power to the storage battery 8 to charge the storage battery 8, and the process returns to S1 (S3 in FIG. 2). Specifically, the control unit 43 turns on and conducts the first switch 7, turns off the second switch 32 to cut off the conduction, and operates the voltage conversion unit 9. Accordingly, as indicated by an arrow A in FIG. 3, power is supplied from the power supply 3 to the voltage conversion unit 9 through the first wiring 5, the contact 29, and the second wiring 31, the voltage is stepped up and down, and the stepped up and down power is supplied to the storage battery 8 through the fourth wiring 35.

When S2 is executed, the control unit 43 determines whether the driving mode is the autonomous driving mode based on the mode information received from the input device 50. As a result, when it is determined that the driving mode is the autonomous driving mode, the process proceeds to S5, and when it is determined that the driving mode is not the autonomous driving mode (manual driving mode), the process ends (S4 in FIG. 2). When it is determined in S4 that the driving mode is the autonomous driving mode, the control unit 43 determines whether power can be supplied from the power supply 3 to the first load 13 and the second load 6. As a result, when it is determined that power supply is possible, the process proceeds to step S6; otherwise, the process proceeds to step S7 (step S5 in FIG. 2). When it is determined in S5 that power can be supplied from the power supply 3 to the first load 13 and the second load 6, the control unit 43 supplies power from the power supply 3 to the first load 13 and the second load 6, and the process proceeds to S8 (S6 in FIG. 2). Specifically, the control unit 43 supplies power from the power supply 3 to the second load 6 through the first wiring 5 as indicated by an arrow B in FIG. 3. At this time, the control unit 43 also supplies power from the power supply 3 to the first load 13 through the first wiring 5, the contact 15, and the first branch wiring 17 as indicated by an arrow C in FIG. 3. Traveling of the vehicle executed by supplying power to the second load 6 and the first load 13 along the paths indicated by arrows B and C in FIG. 3 is referred to as normal traveling.

When S6 is executed, the control unit 43 determines whether an OFF signal is received from the IG switch 49, and when it is determined that the OFF signal is received, the process proceeds to S9, and when it is determined that no OFF signal is received, the process returns to S4 (S8 in FIG. 2). When it is determined in S8 that the OFF signal is received, the control unit 43 stops the power supply system 1 and ends the process (S9 in FIG. 2).

When it is determined in S5 that power cannot be supplied from the power supply 3 to the first load 13 or the second load 6, the control unit 43 turns off the first switch 7 to cut off the conduction, turns on and conduct the second switch 32, and proceeds to S10 (S7 in FIG. 2). Accordingly, the control unit 43 supplies power from the storage battery 8 to the second load 6 through the fourth wiring 35, the third wiring 33, the contact 29, and the connection wiring 5a of the first wiring 5 as indicated by an arrow D in FIG. 4. The second load 6 supplied with power causes the vehicle to travel to a safe place, and stops the vehicle when the vehicle reaches the safe place. The traveling of the vehicle executed by supplying power along the path indicated by the arrow D in FIG. 4 is referred to as evacuation traveling. Even when the OFF signal is received from the IG switch 49 to the control unit 43 during evacuation traveling, the control unit 43 neither accepts the OFF signal nor stops supplying power to the second load 6 as illustrated in S7 of FIG. 2. This is because the second load 6 is disconnected from the storage battery 8 when the supply of power to the second load 6 is stopped by receiving the OFF signal. When S7 is executed, the control unit 43 determines whether the evacuation traveling has ended. When it is determined that the evacuation traveling has ended, the process ends, and when it is determined that the evacuation traveling has not ended, the process returns to S7 (S10 in FIG. 2). Examples of a case where the evacuation traveling has ended include a case where an output voltage of the storage battery 8 reaches a prescribed lower limit voltage, that is, a case where the storage battery 8 runs out. A case where the control unit 43 receives a signal indicating that the evacuation traveling has ended from the input device 50 is also an example of a case where the evacuation traveling has ended. When the evacuation traveling has ended, the control unit 43 may stop supplying power from the storage battery 8 to the second load 6. Alternatively, when it is necessary to operate a device constituting the second load 6, such as a hazard lamp, a horn, and an emergency call, even after the evacuation traveling, the control unit 43 may continue to supply power from the storage battery 8 to the second load 6 even after the evacuation traveling.

Here, when the output unit 12 of the voltage conversion unit 9 has a ground fault in a state where the storage battery 8 is electrically connected to the voltage conversion unit 9, the ground fault current flows from the storage battery 8 toward the output unit 12 of the voltage conversion unit 9 as indicated by an arrow E in FIG. 5. However, the voltage conversion unit 9 is protected since the first fuse 37 is blown by the ground fault current. In addition, the first switch 7 is ON at a time when the power supply system 1 turns on the power supply, for example, at a time of S2 or S3 in FIG. 2. Accordingly, when the input unit 10 of the voltage conversion unit 9 has a ground fault, the ground fault current flows from the lead storage battery 4 toward the input unit 10 of the voltage conversion unit 9 as indicated by an arrow F in FIG. 5. However, the voltage conversion unit 9 is protected since the second fuse 39 is blown by the ground fault current. The operation of the power supply system 1 has been described above.

In this way, the power supply system 1 according to the first embodiment includes the power supply 3, the storage battery 8, the voltage conversion unit 9, and the pair of cutoff units 11. In the pair of cutoff units 11, the first cutoff unit 11a provided at the output unit 12 of the voltage conversion unit 9 is the first fuse 37. With this configuration, when the output unit 12 of the voltage conversion unit 9 has a ground fault, the first fuse 37 is blown by the ground fault current flowing toward the output unit 12 of the voltage conversion unit 9, and the voltage conversion unit 9 is protected. For this reason, the power supply system 1 can protect the voltage conversion unit 9 from the ground fault current with a less expensive and simpler structure than that in the related art.

In the pair of cutoff units 11 of the power supply system 1 according to the first embodiment, the second cutoff unit 11b provided at the input unit 10 of the voltage conversion unit 9 is the second fuse 39 that is blown when the ground fault current flows thereinto. With this configuration, when the input unit 10 of the voltage conversion unit 9 has a ground fault, the second fuse 39 is blown by the ground fault current flowing toward the input unit 10 of the voltage conversion unit 9, and the voltage conversion unit 9 is protected. For this reason, the power supply system 1 can protect the voltage conversion unit 9 from the ground fault current that flows thereinto from not only the output unit 12 but also the input unit 10 of the voltage conversion unit 9.

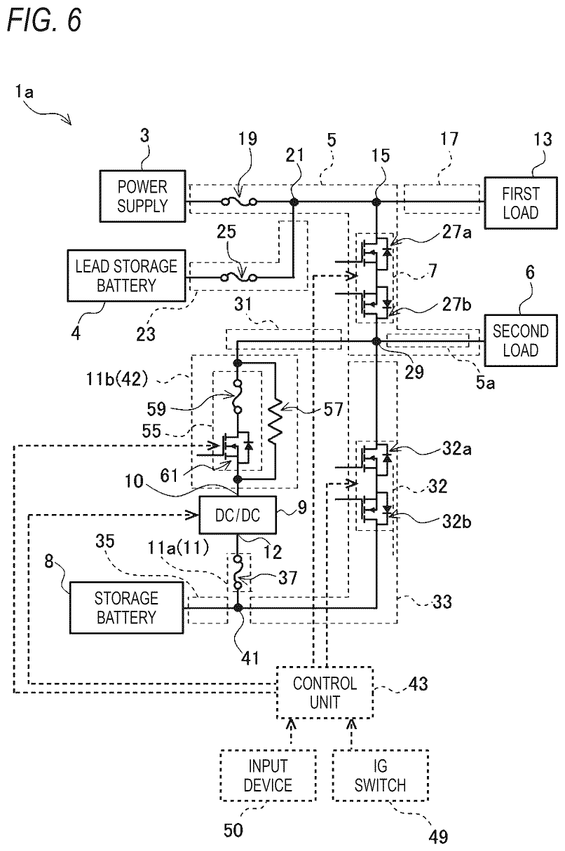

Next, a second embodiment will be described with reference to FIG. 6. In the second embodiment, the second cutoff unit 11b in the first embodiment is replaced with an inrush current prevention circuit. In the second embodiment, elements having the same functions as those in the first embodiment are given the same reference numerals, and differences from the first embodiment will be mainly described.

FIG. 6 is a configuration diagram showing a power supply system according to the second embodiment. As illustrated in FIG. 6, in a power supply system la according to the second embodiment, the second cutoff unit 11b is an inrush current prevention circuit 42 that prevents an inrush current from flowing from the power supply 3 into the voltage conversion unit 9. With this configuration, the inrush current prevention circuit 42 can also prevent the inrush current from flowing into the voltage conversion unit 9 immediately after the power supply 3 is activated.

The inrush current prevention circuit 42 shown in FIG. 6 includes a series circuit 55 and a resistor 57. The series circuit 55 supplies power supplied from the power supply 3 to the voltage conversion unit 9 when there is no possibility that an inrush current flows, and connects the second wiring 31 and the input unit 10 of the voltage conversion unit 9. The series circuit 55 shown in FIG. 6 includes a third fuse 59 and a third switch 61. The third fuse 59 protects the third switch 61 and the voltage conversion unit 9 from a ground fault current that flows toward the input unit 10 of the voltage conversion unit 9 when the input unit 10 has a ground fault, and is blown by the ground fault current. The third fuse 59 may be a known fuse in which a cutoff current is equal to or less than the ground fault current and is larger than a current that flows when power is supplied to the storage battery 8, which is similar to the first fuse 37. The third switch 61 is turned off when there is a possibility that an inrush current flows and is turned on when there is no possibility that an inrush current flows, and is connected in series to a terminal of the third fuse 59 which is close to the voltage conversion unit 9. An example of the third switch 61 is a MOSFET. Connection and disconnection of the third switch 61 may be controlled by the control unit 43. The resistor 57 is an element through which a current flows immediately after the power supply 3 is activated, and is connected in parallel to the series circuit 55. The resistor 57 has such a resistance value that a desired amount of power can be consumed when the ground fault current or a peak current generated immediately after activation of the power supply 3 flows thereinto. The resistor 57 has such rated power that the resistor 57 operates with the peak current that flows thereinto immediately after the power supply 3 is activated. The peak current has substantially the same current value as the ground fault current. Accordingly, the resistor 57 would not be burned out even when the ground fault current flows through the resistor 57 as long as the rated power is sufficient to operate with the peak current.

In the inrush current prevention circuit 42 shown in FIG. 6, immediately after the activation of the power supply 3, the control unit 43 turns off the third switch 61 to cut off the conduction, and causes a current supplied from the power supply 3 to flow toward the resistor 57, thereby preventing an inrush current from flowing into the voltage conversion unit 9. In addition, in the inrush current prevention circuit 42, when there is no possibility that an inrush current flows due to a lapse of prescribed time or the like after the activation of the power supply 3, the third switch 61 is turned on to be conductive, and a current flows to the voltage conversion unit 9 without passing through the resistor 57, thereby suppressing a loss of power. Further, when the input unit 10 of the voltage conversion unit 9 has a ground fault in a state where the third switch 61 is turned on, the third fuse 59 is blown by a ground fault current flowing from the lead storage battery 4 to the input unit 10 of the voltage conversion unit 9, and the ground fault current flows into the resistor 57 to consume power. For this reason, the inrush current prevention circuit 42 can prevent the ground fault current from directly flowing into the input unit 10 while preventing the inrush current from flowing into the voltage conversion unit 9. The power supply system la according to the second embodiment has been described above.

Although the present disclosure has been described above based on the embodiments, the present disclosure is not limited to the above embodiments, and modifications may be made without departing from the gist of the present disclosure and other techniques may be appropriately combined if possible. Further, public or well-known techniques may be combined if possible.

For example, in the second embodiment, no fuse is connected in series with the resistor 57. However, to protect the resistor 57 when the input unit 10 has a ground fault and the third switch 61 is broken and turned off and a current continues to flow through the resistor 57, a fuse may be connected in series to a terminal of the resistor 57 on the second wiring 31.

What is claimed is:

1. A power supply system comprising:
a power supply that supplies power to a load via a first wiring;
a storage battery that stores power supplied from the power supply via a second wiring connected to the first wiring and that supplies power to the load when the power supply fails to supply power to the load;
a first switch that is provided on the first wiring between a connection portion with the second wiring and the power supply and is conducted when the power supply supplies power to the load;
a voltage conversion unit that connects the second wiring and the storage battery and that steps up and down a voltage of power supplied from the power supply;
a second switch that is connected in parallel with the second wiring and the voltage conversion unit and that is conducted when the storage battery supplies power to the load;
a first cutoff unit that is provided at an output unit of the voltage conversion unit and that cut off a current when a ground fault current flows in; and
a second cutoff unit that is provided at an input unit of the voltage conversion unit and that cut off a current when a ground fault current flows in, wherein
the first cutoff unit is a first fuse that cuts off a current by being blown when a ground fault current flows thereinto.

2. The power supply system according to claim 1, wherein
the second cutoff unit is a second fuse that is blown when a ground fault current flows thereinto.

3. The power supply system according to claim 1, wherein
the second cutoff unit is an inrush current prevention circuit that prevents an inrush current from the power supply from flowing into the voltage conversion unit.

4. The power supply system according to claim 3, wherein
the inrush current prevention circuit includes
a series circuit including a third fuse that is blown when a ground fault current flows thereinto and a third switch connected in series to a terminal of the third fuse which is close to the voltage conversion unit, and
a resistor connected in parallel to the series circuit.
